(19) United States
(12) Patent Application Publication
(10) Pub. No.: US 2002/0118919 A1
(43) Pub. Date: Aug. 29, 2002

(54) Optical fiber line

(76) Inventor: Maria Bruchmann, Bad Waltersdorf (AT)

Correspondence Address: Henry M. Feiereisen, Suite 3220, 350 Fifth Avenue, New York, NY, 10118, US

(21) Appl. No.: 10/054,753

(22) Filed: Jan. 22, 2002

Related U.S. Application Data
(60) Provisional application No. 60/264,047, filed on Jan. 25, 2001.

(30) Foreign Application Priority Data
Jan. 25, 2001 (AT) A 119/2001

(51) Int. Cl. G02B 6/26; G02B 6/16; G02B 6/04; F21V 8/00

(52) U.S. Cl. 385/31; 385/123; 385/115; 385/901; 362/565

(57) ABSTRACT

An optical fiber line for lighting purposes, has one end for introduction of an electromagnetic wave from a light source into the fiber line. The fiber line has a length and is so constructed as to have at least one lateral light exit along the length of the fiber line.

### CROSS-REFERENCES TO RELATED APPLICATIONS

This application claims the benefit of prior filed provisional application, Appl. No. 60/264,047, filed Jan. 25, 2001, pursuant to 35 U.S.C. 119(e), the subject matter of which is incorporated herein by reference.

This application claims the priority of Austrian Patent Application, Serial No. A 119/2001, filed Jan. 25, 2001, the subject matter of which is incorporated herein by reference.

### BACKGROUND OF THE INVENTION

The present invention relates to an optical fiber line for lighting purposes.

In conventional optical fiber lines, an electromagnetic wave from a light source, in particular of a laser, is fed into the fiber line at one end of the fiber line and exits at the other end. This is disadvantageous because the light exits only in the form of a spot.

It would therefore be desirable and advantageous to provide an improved optical fiber line, which obviates prior art shortcomings.

### SUMMARY OF THE INVENTION

According to one aspect of the present invention, an optical fiber line for lighting purposes, includes one end for introduction of an electromagnetic wave from a light source into the fiber line, with the fiber line having a length and being so constructed as to have at least one lateral light exit along the length of the fiber line.

The present invention resolves prior art problems by providing at least one lateral light exit, so that the need for a separate fiber line for each light exit is eliminated, and as a consequence the number of fiber lines can be reduced.

According to a further feature of the invention, the lateral light exit may be provided substantially in the form of a spot. As a conventional fiber line has a spot-like light exit at the end, a spot-like light exit is suitable as replacement for an additional conventional fiber line.

According to a further feature of the invention, at least two, substantially spot-like, lateral light exits may be so arranged that neighboring substantially spot-like, lateral light exits at least partially overlap. As a consequence of the overlap of several, substantially spot-like, lateral light exits, the intensity of the illumination can be enhanced.

According to a further feature of the invention, the lateral light exit may be linear along a section of the fiber line. The distribution of the radiant power over a larger region can improve the illumination.

According to another feature of the invention, the lateral light exit may be configured as kink. This configuration of the lateral light exit facilitates fabrication and affords the option to provide a particularly space-saving directional change of the fiber line in the area of the lateral light exit.

According to a further feature of the invention, at least two fiber lines may be combined to a bundle of fibers. By combining the fiber lines, the electromagnetic wave can be fed more easily from a common light source.

According to a further feature of the invention, the fiber line may be connected with an object, such as, e.g., a vase, a fountain, a candle holder, a painting and the like. Connecting the fiber line with an object allows use of the objects as lighting fixture. When the object is a picture, at least one region of the fiber line extends on the picture side. The integration of at least one region of the fiber line with the picture side affords the option to combine the illumination with the content of the picture.

According to another feature of the invention, the fiber line may be drawn through stitches of textile products, in particular woven fabrics or canvases and, at least partially incorporated therein. In textile products, the fiber line may be drawn through existing stitches of the material, without damaging them. The incorporation results in a permanent connection between fiber line and material, without additional means.

According to as further feature of the invention, the fiber line may be embedded in a body that is at least partially translucent. This combination affords the possibility to protect the fiber line against damage and to allow use of at least partially translucent bodies as lighting fixtures.

According to a further feature of the invention, the fiber line may be cast within at least partially translucent or transparent materials, in particular plastic or glass. Casting a part of th e fiber line enables a connection with an article already during manufacture of the article.

It is also conceivable to make the fiber line as part of a decoration. The use of a fiber line according to the present invention does not require light bulbs in the area of the decoration. Therefore, it is no longer required to so configure the decoration as to allow replacement of spent bulbs.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross sectional view of one embodiment of a fiber line according to the invention with a lateral light exit; and

FIG. 2 is a top view of a picture having incorporated therein a portion of a fiber line according to the invention on the picture side.

### DETAILED DESCRIPTION OF PREFERRED EMBODIMENTS

Throughout all the Figures, same or corresponding elements are generally indicated by same reference numerals.

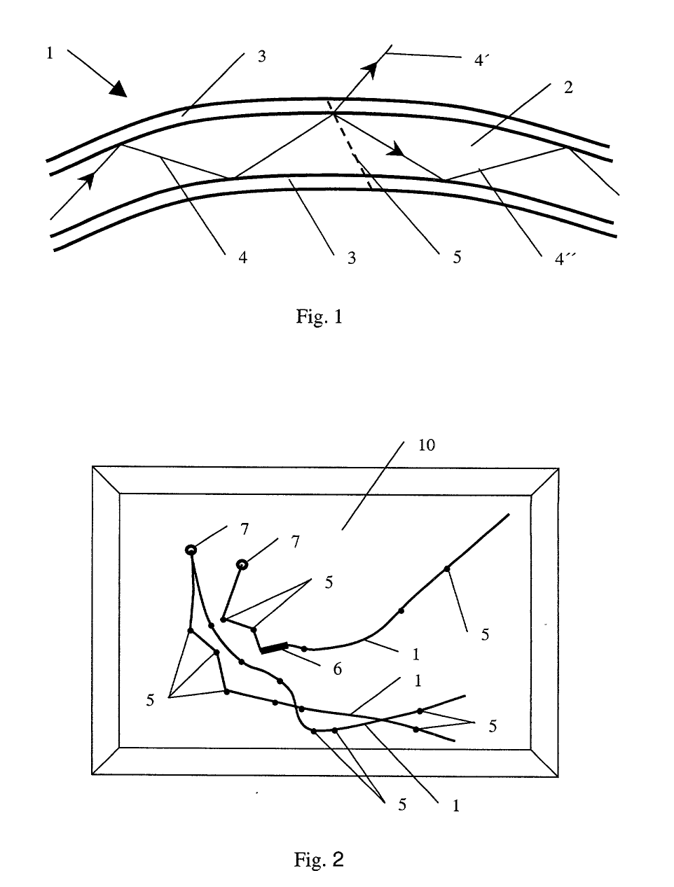

Turning now to the drawing, and in particular to FIG. 1, there is shown a principal configuration of an optical fiber line according to the invention, generally designated by reference numeral 1 intended for conducting an electromagnetic wave generated by a light source, in particular a laser, and fed into the fiber line 1 at one end of the fiber line 1. The fiber line 1 includes a core 2 and a sheath 3 having different indices of refraction. The operation of the fiber line 1 is based on a total reflection of a ray of light 4 of the electromagnetic wave upon the interface between the core 2 and the sheath 3. Of course, it is also possible to so configure the fiber line 1 in which the interface between the core 2 and the sheath 3 is not sharply established but rather a continuous transition exists between the core 2 and the sheath 3.

The fiber line 1 according to the invention is provided with a lateral light exit 5. Part of the incident light rays 4 exits the fiber line 1 laterally as an exiting light rays denoted by reference numeral 4′, while another part of the incident light ray 4 remains in the fiber line 1 as reflected light rays denoted by reference numeral 4″.

The lateral light exit 5 may be implemented, e.g., by a mechanical kink, thereby realizing primarily an essentially spot-like lateral light exit 5. Hereby, the radius of curvature of the fiber line 1 is reduced to such an extent that the material of the fiber line 1 is plastically deformed. As a result, the refractive index of the core and/or the sheath 3 changes so that a total reflection no longer occurs at this location in the area of the interface and, as a consequence, the light ray 4 exits laterally. In the event, the core 2 of the fiber line 1 is made of glass, the formation of the kink results in a breakage of the glass. At the breaking point, part of the incident light rays 4 are so deflected as to exit the fiber line 1. Regardless whether the kink results in a plastic deformation or in a breaking point, the substantially spot-like lateral light exit 5 is maintained even when the fiber line 1 is straightened.

It is also possible to remove material of the sheath 3 of the fiber line 1 up to the interface. Also in this case, total reflection is no longer encountered in this region, so that a part of the incident light rays 4 exits the fiber line 1 laterally.

By tightly juxtaposing several, substantially spot-like lateral light exits 5, the effect of a linear light exit 6 is realized, as indicated in FIG. 2. This effect is based on the fact that neighboring, substantially spot-like lateral light exits 5 are so disposed as to at least partially overlap. As an alternative, a removal of material of the sheath 3 along a portion of the fiber line 1 also results in a linear light exit 6.

In order to be able to feed electromagnetic waves from a light source into several fiber lines 1, several fiber lines 1 may be combined to form a bunch of fibers.

The fiber line 1 according to the invention allows use of different objects as lighting fixtures. It is therefore possible to combine the fiber lines 1, for example, with a vase, a fountain, a candle holder, or a picture 10, as shown by way of example in FIG. 2. Compared to a lighting fixture with a number of light bulbs, the fiber line 1 is advantageous because no glow wire is attached at the lateral light exits 5 so that the heat generation is only slight. Light bulbs always encounter burnout and require lighting fixtures that are so configured to permit a replacement of a defective light bulb. This is not an issue in the case of the fiber line 1 in view of its high wear resistance.

In contrast to a light bulb, no electric current flows in the fiber line 1 so that the fiber line 1 can safely be used in wet spaces. In this context, bathtubs, shower sinks, shower booths or bathtub booths, washing sinks and the like may be used as lighting fixtures. Other embodiments of lighting fixtures which include the fiber line 1 according to the invention involve curtains, floors, tiles, walls, ceilings and the like.

Protection of the fiber line 1 is possible especially when embedded in an object. Hereby, it is required that the object is at least partially translucent. Possible embodiments include bottle coolers, candle stands, vases and the like. This variation is advantageous because the fiber line 1 is protected from mechanical damage. As the fiber line 1 does not include wearing parts, it is not necessary to make the embedded zone accessible.

A simple manufacturing process is realized when the fiber line 1 can be cast during production of the object. This is, for example, possible for objects made of plastic or glass.

FIG. 2 illustrates a picture 10, which has an area of the fiber line 1 on the picture side. The fiber line 1 may be used to highlight contours and thereby form a designing element of the picture 10. The spot-like lateral light exits 5 of the fiber lines 1 are shown by dots. Further shown in FIG. 1 is one fiber line 1 with linear light exit 6. The fiber lines 1 are guided through bores 7 from the backside of the picture 10 to the picture side. The structure of the picture base, in particular an intermediate space of the fiber may be used for the bores 7. Optionally, at least one of the fiber lines 1 is routed through a further bore 7 from the picture side to the backside of the picture again. It is also conceivable for at least one of the fiber lines 1 to be routed across the side of the picture 10, optionally across the frame, to the picture side.

Although not shown in detail, it is also conceivable to thread the fiber lines 1 through stitches of a canvas of the picture 10, a textile fabric or like structure. A good connection between the canvas and the fiber line 1 can be realized when the fiber line 1 is at least partially integrated in the structure of the canvas. The fiber line 1 can also be secured to the picture 10 by an adhesive, e.g., silicone glue, or by acryl paints or oil paints. This process of securing the fiber line 1 is suitable for most woven materials.

A further option of application of the fiber line 1 according to the invention involves the use for decorative purposes. Hereby, the fiber line 1 has the advantage of being free of any wearing parts, unlike a string of lights with light bulbs. Conventional fiber lines are rarely used for decorative purposes because a separate fiber line is required for each point of light. However, a fiber line 1 according to the invention may be provided with several lateral light exits 5, 6, thereby significantly reducing the number of required fiber lines 1.

While the invention has been illustrated and described as embodied in an optical fiber line, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. An optical fiber line for lighting purposes, said fiber line having one end for introduction of an electromagnetic wave from a light source into the fiber line, said fiber line having a length and being so constructed as to have at least one lateral light exit along the length of the fiber line.

2. The optical fiber line of claim 1, wherein the light source is a laser.

3. The optical fiber line of claim 1, wherein the lateral light exit is substantially in the form of a spot.

4. The optical fiber line of claim 3, and further comprising a plurality of said substantially spot-like lateral light exit along the length of the fiber line, wherein neighboring light exits at least partially overlap.

5. The optical fiber line of claim 1, wherein the lateral light exit is linear along a portion of the fiber line.

6. The optical fiber line of claim 1, wherein the lateral light exit is formed by a kink in the fiber line.

7. The optical fiber line of claim 1 in combination with at least another said optical fiber line to form a bundle of fiber lines.

8. The optical fiber line of claim 1 for connection with an object of the group consisting of vase, fountain, candle holder, and picture.

9. The optical fiber line of claim 8, wherein the object is a picture having a picture side, wherein at least one region of the fiber line extends on the picture side.

10. The optical fiber line of claim 1, wherein the fiber line is drawn through stitches of a textile product and at least partially incorporated therein.

11. The optical fiber line of claim 10, wherein the textile product is a woven fabric or a canvas.

12. The optical fiber line of claim 1 for embedment in a body that is at least partially translucent.

13. The optical fiber line of claim 1 being cast within a material which is at least partially translucent or transparent material.

14. The optical fiber line of claim 1, wherein the material is plastic or glass.

15. The optical fiber line of claim 1 being part of a decoration.
